(19) United States
(12) Patent Application Publication
(10) Pub. No.: US 2025/0137431 A1
(43) Pub. Date: May 1, 2025

(54) SUBMERSIBLE BOX-WINGED VEHICLE SYSTEMS AND METHODS FOR GENERATING HYDROELECTRIC ENERGY

(71) Applicant: EMBRAER S.A., São José dos Campos – SP (BR)

(72) Inventors: Fabricio Reis CALDEIRA, São José dos Campos – SP (BR); Marcelo GALVAO, São José dos Campos – SP (BR); Pedro David Bravo MOSQUERA, São José dos Campos – SP (BR); Luiz Fernando Tedeschi OLIVEIRA, São José dos Campos – SP (BR); Lallo Kametada NOU, São José dos Campos / SP (BR); Marcos VINICIUS, São José dos Campos – SP (BR)

(21) Appl. No.: 18/918,498

(22) Filed: Oct. 17, 2024

Related U.S. Application Data
(60) Provisional application No. 63/593,037, filed on Oct. 25, 2023.

(51) Int. Cl. F03B 13/26; B63B 21/50; B63B 35/44; B63G 8/00; B63G 8/04; B63G 8/20; B63G 8/22; C25B 9/65

(52) U.S. Cl. CPC F03B 13/26; B63B 21/50; B63B 35/44; B63G 8/001; B63G 8/04; B63G 8/20; B63G 8/22; C25B 9/65; B63B 2035/446; B63G 2008/002; F05B 2240/97

(57) ABSTRACT

Submersible box-winged vehicle systems generate hydroelectric energy using naturally occurring tidal flows and/or water currents in a body of water. The vehicle systems include a submersible hull, an upright dorsal fin extending from an aft portion of the submersible hull, port and starboard wing assemblies each having respective proximal ends joined to a forward region of the hull an and an upper region of the dorsal fin so as to establish a box wing configuration, and electrical power generation units attached to the port and starboard wings, wherein each of the electrical power generation units include a generator and a marine propeller operatively connected to the generator so as to cause the generator to generate electrical energy in response to the marine propeller turning. The vehicle system when submerged in a body of water thereby allows tidal flows and/or currents associated with the body of water to responsively turn the marine propeller of each of the electrical power units thereby generating electricity by the generator operably associated therewith

### CROSS-REFERENCE TO RELATED APPLICATION

This application is based on and claims domestic priority benefits from U.S. Provisional Application Ser. No. 63/593,037 filed on Oct. 25, 2023, the entire content of which is expressly incorporated hereinto by reference.

### FIELD

The embodiments disclosed herein relate generally to the generation of hydroelectric energy. In preferred embodiments, submersible box-winged vehicle systems and methods are provided which allow for the hydroelectric generation of “clean” energy using naturally occurring tidal flows and/or currents in bodies of water, e.g., oceans, seas, rivers and the like.

### BACKGROUND

The transition of the global energy sector from fossil-based systems to renewable energy sources is this century's biggest challenge. Regulation and commitment to decarbonization has been mixed, but the energy transition will continue to increase in importance as investors prioritize environmental, social and governance (ESG) factors. Also, energy transitioning will likely accelerate as the practical impacts of global warming become more evident to society.

According to “Our World in Data” website, only 11% of the current global energetic matrix is derived from renewable energy sources (i.e., solar, wind and hydropower). So far, approximately 0% of renewable energy is derived from energy associated with ocean currents. Many companies are however developing prototypes to harness energy from ocean currents but thus far a viable solution has not become a commercial reality.

One principal issue with deriving clean energy from solar and wind is that the sources for such energy are not predictable. Large energy storage, such as batteries, would be required to provide an uninterrupted energy supply when there is no sunlight or wind available. One main advantage of tidal flows and ocean currents is that they are predictable. Energy harnessed from ocean water flows can thus be used as a complement to wind and/or solar energy sources to reduce the need for energy storage and to allow for the transition from fossil fuel to renewable energy sources.

Although the water flow from oceans is much denser than the airflow from winds and ocean currents are more predictable than winds, the ocean water flow (tides and currents) speeds are relatively slow. This in turn presents unique issues when attempting to design a system that generates hydroelectric energy from such water flows.

In order to efficiently harness energy from ocean water flows (tides and currents) a fixed wing frame is designed, because it is very efficient (Kg/MW) to harvest kinetic energy from water flow. For the same power, the wing area compared to conventional stationary turbines is extremely small. Also, even if the flow is slow, it is possible to generate power by increasing the relative speed of the turbine attached to the wing frame. The electricity is generated through the drag concept, where the rotor slows down/reduces wing speed. The rotor drag slows down the speed of the water molecules and the kinetic power from the water molecules is converted into electric power. The power is generated in the vehicle system and transmitted to the grid through an electrical cable.

The speed of a turbine attached to a submerged fixed wing is much higher than the water flow. As an example, for a water flow of 1.5 m/sec, the wing speed can be up to 10 m/sec. As the turbine power is proportional to speed cubed (v³), if there is a factor of 6 times increase in speed with an increased factor in power of 6³=216 times.

What has been needed in this art therefore are new submersible fixed-wing vehicle designs which allow for the efficient harvesting of hydroelectrically generated energy from naturally occurring tidal flows and/or water currents in bodies of water, e.g., oceans, seas, rivers and the like. It is towards providing solutions which meet such needs that the embodiments disclosed herein are directed.

### SUMMARY

Broadly, the embodiments disclosed herein are directed toward novel submersible box-winged vehicle system (colloquially known as a Tethered Undersea Kite (TUSK)) that may be used to hydroelectrically generate energy from naturally occurring tidal flows and/or currents in bodies of water. The embodiments disclosed herein offer promising advantages, primarily in their capacity to harness greater energy from ocean currents or tidal streams as compared to fixed marine turbines of equivalent size. This potential is achievable because the box-winged vehicle systems of the embodiments disclosed herein can execute lateral movements at speeds surpassing the current's own velocity, thereby amplifying power generation when contrasted with marine turbines of equivalent dimensions. In this context, the box-wing design offers numerous advantages in terms of improved hydrodynamic efficiency, increased lift capacity, enhanced stability, and reduced drag.

The box-wing configuration employed in the submersible vehicle system embodiments as disclosed herein provides for a more hydrodynamically efficient lifting solution that may introduce several improvements to the overall vehicle system performance. The box-wing concept, as the name suggests, has a wing configuration that resembles a box or a rectangular shape when viewed from the front or top.

The box-wing configuration will typically include three main wing components on each of the port and starboard sides of the hull. A fore wing is positioned at the front of the vehicle system and plays a crucial role in providing lift and stability. The fore wing helps distribute the lift forces evenly across the wingspan, contributing to better aerodynamic performance. The aft wing is positioned behind the fore wing and is often larger. The aft wing also generates lift but is primarily responsible for fine-tuning the vehicle system's stability and control. The aft wing can house moveable hydroplane control surfaces which are used to maneuver the vehicle system and adjust its attitude during operation along roll and pitch axes. Curved vertical wings connect the respective distal edges of the fore and aft wings so as to provide structural support and rigidity to the box-wing configuration. The vertical curved wings can also help reduce the interference between the fore and aft wings, minimizing wingtip vortices and associated induced drag thereby contributing to improved aerodynamic efficiency.

From a structural standpoint, it is possible to exploit the over-constrained assembly between the lifting system and the hull to achieve overall structural weight reductions. The box-wing design provides a high degree of structural integrity. Such a closed structure is inherently stable and resists torsional forces thereby making it well-suited for withstanding stresses encountered during operation, including turbulence and maneuvers. In addition, the box-wing design distributes the hydrodynamic loads more evenly across the entire wing structure. This balanced load distribution reduces the bending moments on the wings and hull, which can lead to a lighter and more robust submersible vehicle system design. The box-wing design thereby allows for the use of lighter materials without sacrificing strength. On the other hand, if internal available volumes are considered, it is possible to exploit the box-wing configuration to intelligently design wings and/or fuselages to extend the available internal volume. This may be beneficial since a number of batteries need to be stored in the vehicle system.

One key advantage of the design concepts disclosed herein is the possibility to efficiently increase the generated lift which in turn allows heavier vehicle systems to be provided. This is truly relevant when dealing with the development of electric concepts, given the weight penalties due to the on board batteries. Finally, the higher lifting capabilities of the box-wing system can be exploited to reduce the wingspan, satisfying constraints due to the intended under sea operational environment.

From a physical perspective, the challenge to harvest energy from ocean currents is remarkably like the challenge to harvest wind energy. A defining parameter of both, the power density (PW) of a moving medium, is given by the velocity (Vo) and the density (ρ), in the form of:

$$PW = 0.5 ρ {V}_{o}^{3} \qquad ( 1 )$$

Thus, if water is used as a flowing medium (density 998 kg/m³) with an approximately 1000 times higher density than air (1.225 kg/m³ at sea level), the power production increases 800-fold. More importantly, as given in Equation (1) above, the velocity of the medium is cubed. This means that a doubling of the medium velocity leads to an eight-fold increase in power density. This has a direct relation to Floy's power equation, which relates the power required to sustain straight-level operation to various parameters, including the lift coefficient (C_{L}), drag coefficient (C_{D}), wing area(S), air density, and velocity. The equation is as follows:

$$PW = 0.074 ρ S {V}_{o}^{3} {C}_{L}^{3} / {C}_{D}^{2} \qquad ( 2 )$$

Then, a higher CL³/CD² indicates a superior balance between lift and drag, ensuring that the vehicle system can extract a greater amount of energy from the water current. As the vehicle system maneuvers in the ocean currents, the vehicle system's high CL³/CD² allows it to transmit more power to the tether which in turn means that more power can be transferred to an offshore substation.

An important parameter which needs to be addressed is the velocity (Vo). While one can hardly influence the velocity of an ocean current, there are technical solutions to increase the water speed which the turbine experiences. One goal of the embodiments disclosed herein is therefore to effectively increase the ocean current velocity of 2 m/s to a trajectory speed of 12 m/s.

In accordance with preferred embodiments, a submersible box-winged vehicle system is provided so as to generate hydroelectric energy using naturally occurring tidal flows and/or water currents in a body of water. The vehicle system may therefore include a submersible hull (which may be cylindrically shaped), an upright dorsal fin extending from an aft portion of the submersible hull and port and starboard wing assemblies each having respective proximal ends joined to a forward region of the hull an and an upper region of the dorsal fin so as to establish a box wing configuration. Electrical power generation units are attached to the port and starboard wings. Each of the electrical power generation units includes a generator and a marine propeller operatively connected to the generator so as to cause the generator to generate electrical energy in response to the marine propeller turning, wherein the vehicle system when submerged in a body of water allows tidal flows and/or water currents associated with the body of water to responsively turn the marine propeller of each of the electrical power units thereby generating electricity by the generator operably associated therewith.

According to some embodiments, each of the port and starboard wing assemblies may include an aftward swept and upwardly sloped fore wing, a forward swept and downwardly sloped aft wing, and a curved wing tip joining the distal terminal ends of the fore and aft wings such that the port and starboard wing assemblies define a diamond-shaped box wing configuration.

The dorsal fin may include a moveable rudder to control movement of the hull about a yaw axis thereof whereas the port and starboard wing assemblies may comprise moveable port and starboard hydroplane control surfaces (HPS) to control movement of the hull about roll and pitch axes thereof. In some embodiments, the aft wing of each of the port and starboard wing assemblies will comprise a respective one of the port and starboard hydroplane control surfaces. Further, each of the fore and aft wings of each of the port and starboard wing assemblies may comprise at least one (preferably multiple) electrical power generation units. The electrical power generation units may also comprise a nacelle attached to a respective one of the port and starboard wings, wherein each generator is enclosed by a respective nacelle.

These and other aspects and advantages of the present invention will become clearer after careful consideration is given to the following detailed description of the preferred exemplary embodiments thereof.

### BRIEF DESCRIPTION OF ACCOMPANYING DRAWINGS

The disclosed embodiments of the present invention will be better and more completely understood by referring to the following detailed description of exemplary non-limiting illustrative embodiments in conjunction with the drawings of which:

FIGS. 1-9 depict an embodiment of a submersible vehicle system in accordance with an embodiment of the invention, wherein FIG. 1 is a top front perspective view thereof, FIG. 2 is top aft port side perspective view thereof, FIG. 3 is a top aft starboard side perspective view thereof, FIGS. 4 and 5 are respective top and bottom plan views thereof, FIGS. 6 and 7 are respective front and aft elevation views thereof and FIGS. 8 and 9 are respective starboard and port side elevation views thereof;

FIG. 10 is a schematic diagram illustrating the control and system architecture for the submersible vehicle system depicted in FIGS. 1-9;

FIG. 11 is a more detailed schematic diagram illustrating the control and system architecture for the submersible vehicle system depicted in FIGS. 1-9;

FIG. 12 is a schematic view showing one manner in which the submersible vehicle system depicted in FIGS. 1-9 may be towed to an operational position on the surface of a body of water in which hydroelectric energy is to be generated thereby;

FIG. 13 schematically depicts one possible operational system for the generation and use of the hydroelectric energy generated by the submerged vehicle system;

FIG. 14 schematically depicts another possible operational system for the generation and use of the hydroelectric energy generated by the submerged vehicle system;

FIGS. 15A and 15B respectively show baseline and modified configurations for the box-wing designs employed in the estimations of Example 1;

FIGS. 16A and 16B respectively show graphical plots of the induced draft and the hydrodynamic efficiencies conducted in the studies of Example 2; and

FIG. 17 is a graphical illustration of the power gain of fixed wings as compared to turbines according to Example 3.

### DETAILED DESCRIPTION OF EXEMPLARY EMBODIMENT

### I. The Submersible Box-Winged Vehicle System

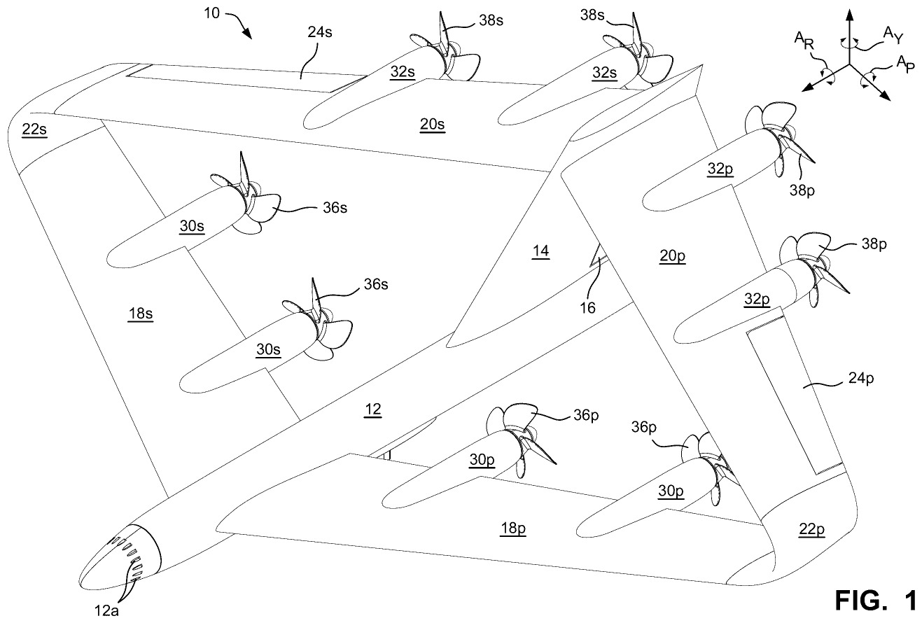

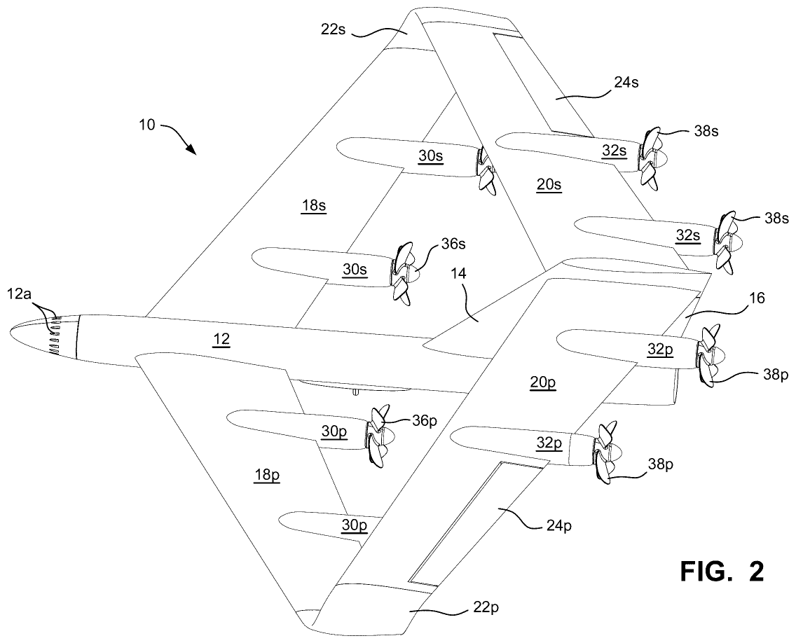

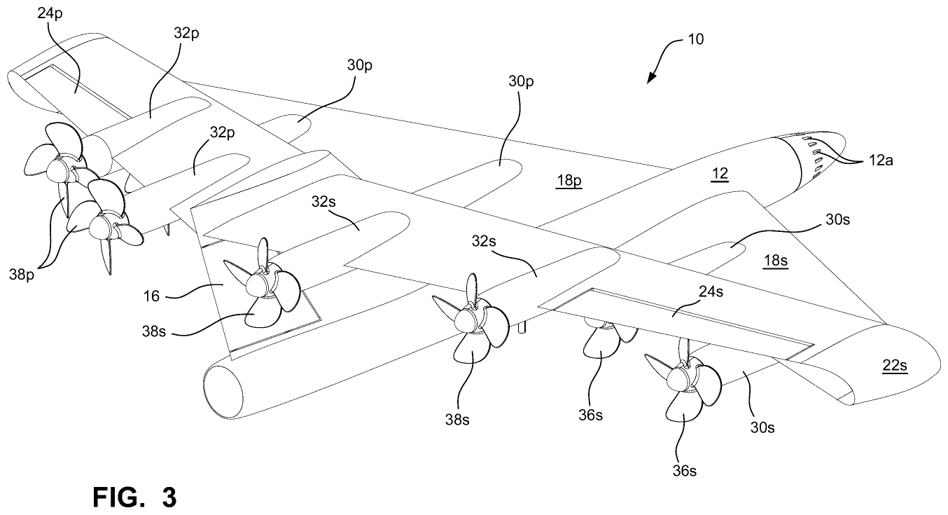

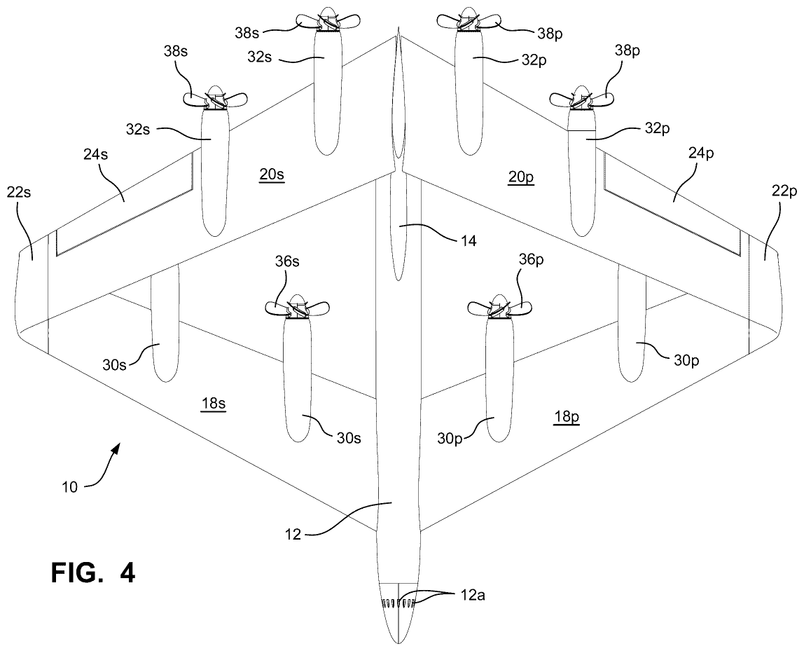

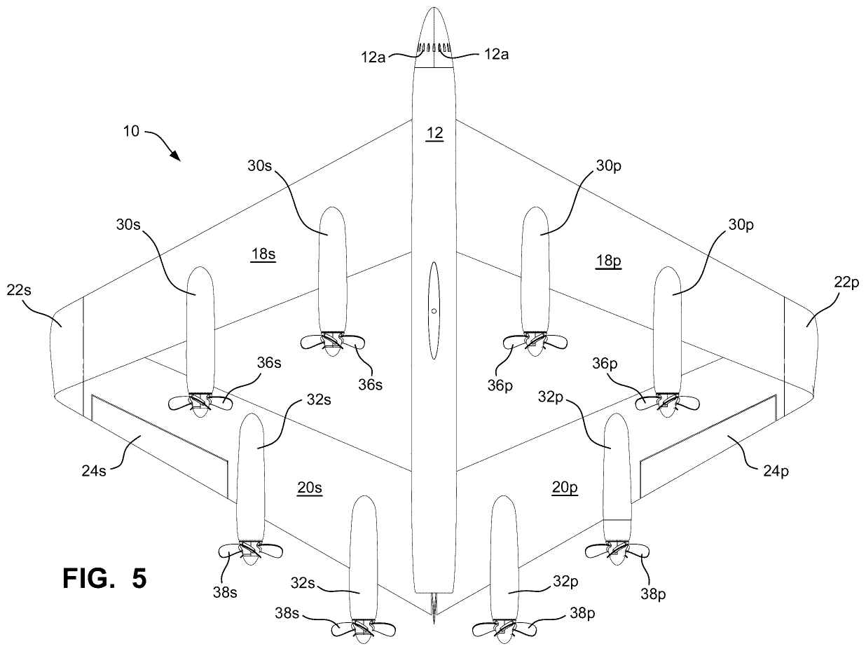

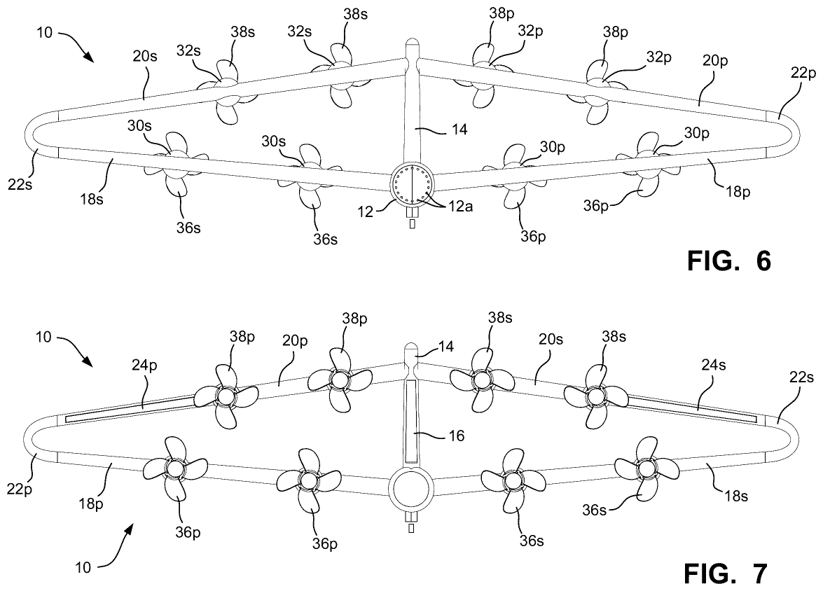

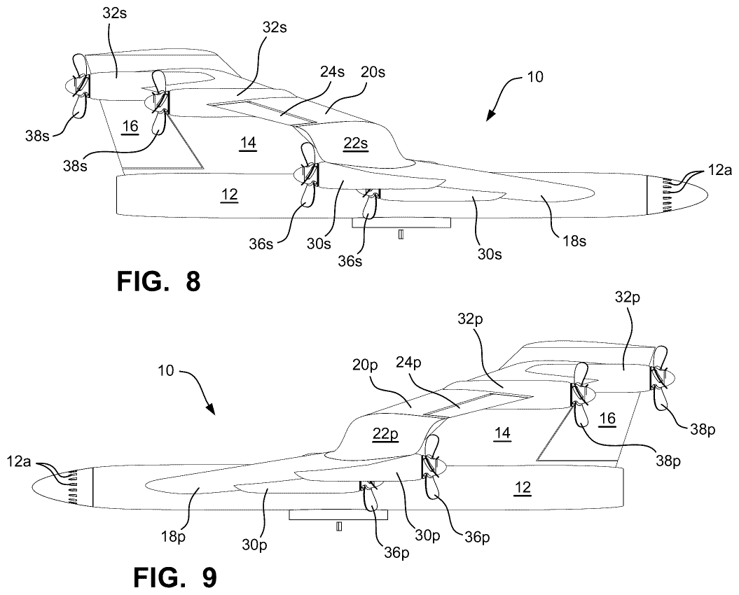

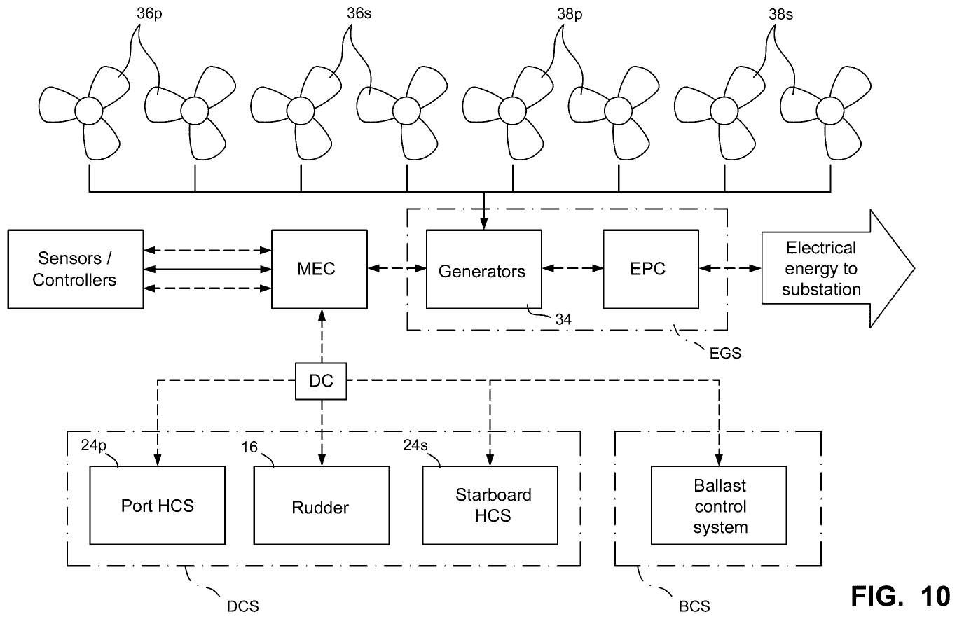

A submersible box-winged vehicle system 10 in accordance with an embodiment of the invention is shown in FIGS. 1-9. As can be seen, the vehicle system 10 includes an elongate cylindrically shaped hull 12 which includes at the aft end thereof a vertical stabilizer dorsal fin 14 provided with a rudder 16 that allows controllable steering of the vehicle system about a yaw axis A_{Y} (see FIG. 1). Aftward swept and upwardly sloped fore wings 18p, 18s respectively extend laterally from the port and starboard sides of the fuselage 12. Forward swept and downwardly sloped aft wings 20p, 20s respectively extend laterally from the upper end regions of the port and starboard sides of the dorsal fin 14. The terminal ends of the port and starboard fore wings 18p, 18s and the port and starboard aft wings 20p, 20s are joined to one another by curved wing tips 22p, 22s, respectively, so as to form a diamond-shaped box wing configuration (see especially FIGS. 4-7). The aft wings 20p, 20s are provided with moveable port and starboard hydroplane control surfaces (HCS) 24p, 24s that may be controllably used in concert to maneuver the vehicle system 10 along roll and pitch axes A_{R} and A_{P}, respectively (see FIG. 1). Each of the wings 18p, 18s and 20p, 20s carries multiple respective nacelles 30p, 30s and 32p, 32s each of which includes an electrical generator 34 (see FIG. 10) coupled operatively to a marine propeller 36p, 36s and 38p, 38s, respectively.

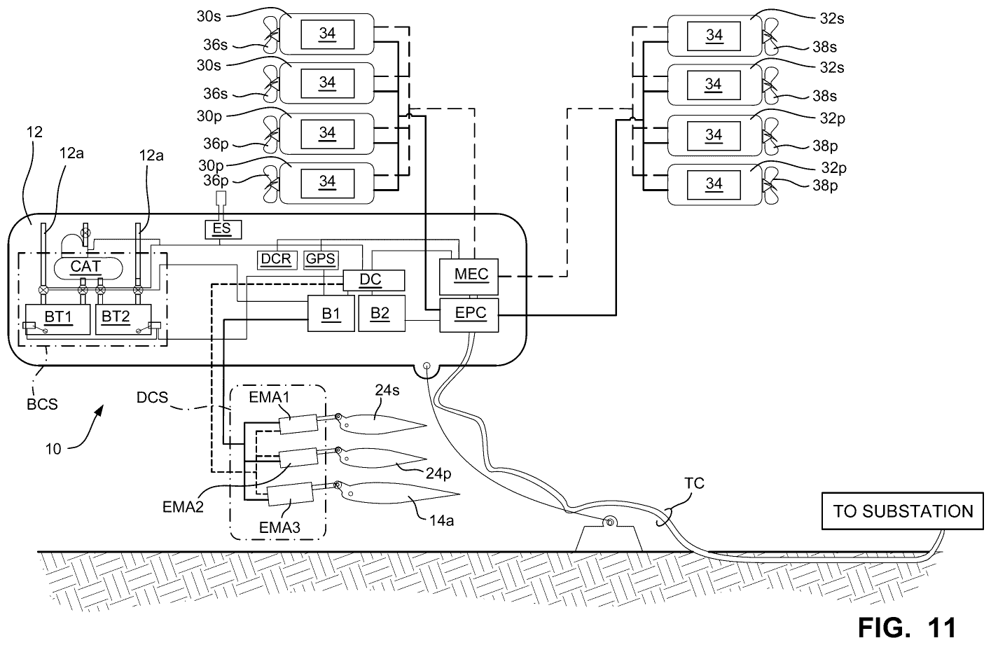

The general system architecture for the vehicle system 10 is shown schematically in FIGS. 10 and 11. The system architecture herein relates to a submersible vehicle system 10 with the propose of generating clean energy through tides and ocean currents. The vehicle system 10 necessitates specific system architecture design to control the overall dynamics of its operation. This involves axis control, optimization of energy absorption, floating, generators, critical conditions, system healthiness and maintenance tasks. In more detail, the technology described herein relates to and provides a proposal of an electronic architecture, mechanism, and methods able to integrate and control, with a high integrity and proper availability.

The operational architecture generally involves a directional control system DCS, a flotation (ballast) system (FBS) and an electricity generation system EGS. The directional control system DCS includes the port HCS 24p, the starboard HCS 24s and rudder 16. Each of the control surfaces 24p, 24s and 16 is actuated by a respective single electromechanical actuator EMA1-EMA3 (see FIG. 11) and their respective positions are controlled by a Multiprotocol Electronic Controller (MEC) which computes all system responses and communicates with the directional controller DC and the electrical power controller EPC. Battery power to the electromechanical actuators EMA1-EMA3 is derived from onboard batteries B1 and B2 which can be charged via the EPC using electricity generated by the generators 34.

The floatation (ballast) system FBS is comprised of ballast tanks BT1, BT2 (see FIG. 11) that can receive water (e.g., via hull inlets 12a) therein to control the density of the vehicle system 10 and hence its buoyancy and submersion depth as well as its center of gravity (CG). Compressed air from the compressed air tank CAT is used to expel water from the ballast tanks BT1, BT2 so as to provide increased buoyancy to the vehicle system 10.

As briefly mentioned previously the electrical generation system EGS is comprised of a plurality of generators 34 enclosed within a nacelle 30p, 30s, 32p and 30s which are operatively coupled to the marine propellers 36p, 36s, 38p and 38s, respectively. Each generator 34 generates electrical energy that may be to be transmitted via transmission cabling TC to a substation. The electricity will be generated by converting kinetic energy of the vehicle system 10. Specifically, the vehicle wings 18p, 18s, 20p and 20s are used to power the related velocity of the vehicle system 10, by inducing a vector conversion from the water flow orientation into a vehicle trajectory with a high incidence angle. In this manner, the propellers 36p, 36s, 38p and 38s will effectively see a much higher induced water flow optimizing the electricity generation. This system will combine the vehicle trajectory and electricity generation to have the maximum efficiency according to tide and ocean currents.

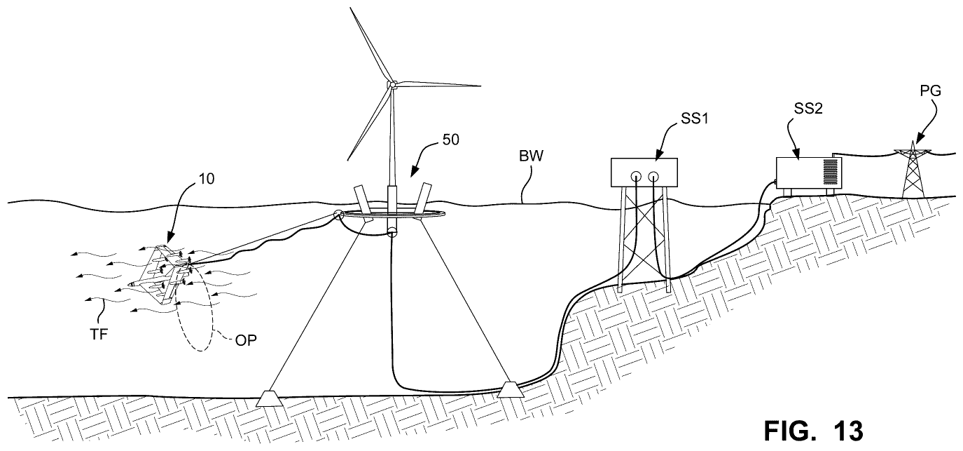

The main controller, denominated as MEC (Multipurpose Electronic Controller), interfaces with all the necessary environmental sensors (collectively identified in FIG. 11 by reference ES), such as probes, inertial system, temperature sensor, angle of attack (AOA) sensor, water pressure sensor, sonars. The MEC controller will also receive signal inputs indicative of the parameters from other systems, such as, positioning of the control surfaces 24p, 24s and 16, electric power produced by the generators 34, volume status of the ballast tanks BT1 and BT2 and the like to form a closed loop system response. The MEC will also have external signal communication via data communication radio DCR with a Power Management System (not shown) responsible for integrating the vehicle system 10 into the National Electrical Grid (see, e.g., the representation of the power grid PG in FIG. 13). This external data communication radio will also allow the vehicle system 10 to transmit its position via an onboard Global Positioning System (GPS) sensor and to provide an interface with maintenance support equipment. External signal communication also can be used for alerting, monitoring, controlling and emergency procedures for the enterprise who will manage the entire network.

### II. Integration of the Submersible Box-Winged Vehicle System with Energy Systems

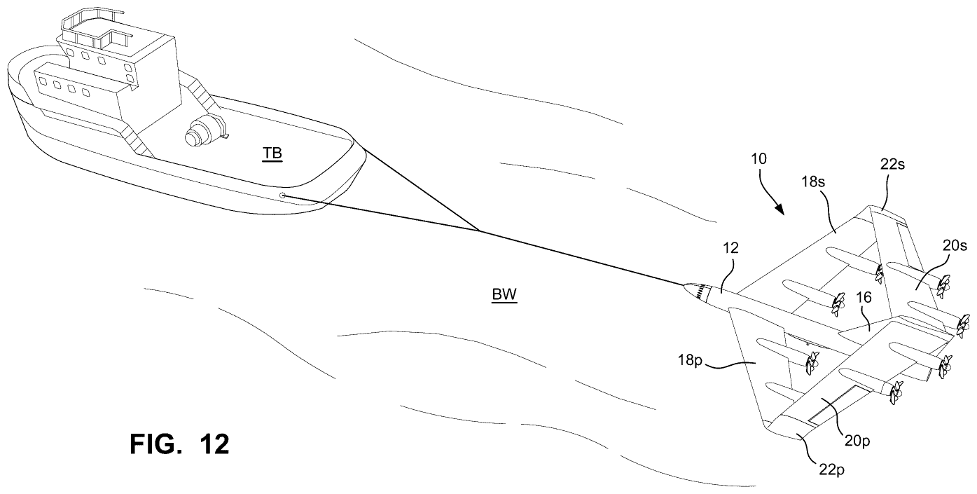

Accompanying FIGS. 12-14 schematical depict a few exemplary ways in which the submersible box-winged vehicle system 10 as described hereinabove can be usefully placed into surface. In this regard, as shown in FIG. 12, the vehicle system 10 may be towed on the surface of a body of water BW by a suitable working marine vessel, e.g., a tugboat TB to a location where the vehicle system 10 is to be operationally deployed. It will be appreciated that in such a floating state, the ballast tanks BT1 and BT2 are essentially empty to thereby impar the necessary buoyancy to allow the hull 12 of the vehicle system 10 to float on the surface of the body of water. Any ballast (e.g., water) contained in the ballast tanks BT1 and/or BT2 will be to provide necessary CG adjustments for the hull 12 depending on the surface conditions of the body of water. Upon arriving at the operational site, the vehicle system may be integrated with an offshore structure or platform, for example an offshore wind-driven turbine system 50 as shown in FIG. 13.

The submersible vehicle system 10 is tethered to the platform of the wind-driven turbine system 50 and submerged to the optimum operational depth for capturing the tidal flow (schematically depicted by the arrows TF in FIG. 13) of the body of water BW. The electrical power generated by both the submersible vehicle system 10 and the offshore wind-driven turbine system 50 may thus be transmitted to an offshore substation SS1 and then on to an onshore substation SS2 where it can then be distributed by the existing transmission lines associated with the power grid PG. As briefly described above, the submerged vehicle system 10 kinetically interacts with the tidal flow TF by controllably moving in an arcuate path OP as shown schematically in FIG. 13 so as to enhance electrical energy generation thereby. It will be appreciated that the vehicle system 10 is shown in FIG. 13 as being positioned relative to an outgoing tidal flow TF (i.e., a tidal flow from a flood tide condition to an ebb tide condition) such that the vehicle system 10 is positioned at the offshore side of the wind-driven turbine system 50. The vehicle system 10 would of course be operationally positioned naturally at the onshore side of the wind-driven turbine system 50 when the tidal flow TF reverses so as to be an incoming tide (i.e., a tidal flow from an ebb tide condition to a flood tide condition).

Integration of the submersible box-winged vehicle system 10 with offshore wind farms allows an increase in capacity factors and predictability by re-using the electrical infrastructure. This integration may allow for an increase of electricity generation (e.g., about 30% or more) with more predictability as compared to the electricity generated only by wind-drive turbines offshore. Also, more predictability means more quality for the energy grid and less energy storage (e.g., batteries) by necessarily using the predictability of the tides. This in turn helps in the challenge of lowering the levelized cost of energy (LCOE) generated by offshore wind-driven turbines.

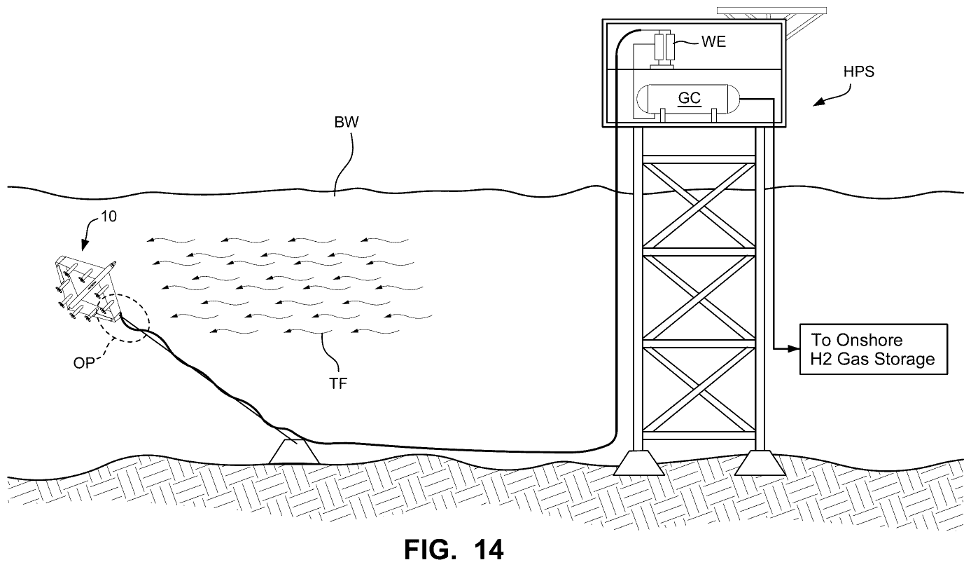

Another possibility is to use the submersible box-winged vehicle system 10 for offshore green hydrogen production whereby H2 gas may be produced by the disassociation of water molecules using the electricity generated by the vehicle system 10. Such a possible integrated offshore H2 production system HPS is depicted in FIG. 14. In the exemplary integrated H2 production system HPS shown therein, the submerged vehicle system 10 may be moored to the seabed of the body of water so as to generate electricity from the tidal flow TF. The electricity may thus be transmitted to the water electrolyzer WE within the H2 production system HPS by transmission cables so as to generate H2 gas that may be temporarily stored in the gas cylinder GC. The generated H2 gas may then be transferred from the gas cylinder GC to an onshore gas storage facility using gas transmission conduits. The H2 gas generated by the H2 production system HPS may thus be used onshore to generate electricity via conventional hydrogen fuel cell technologies.

### III. EXAMPLES

### Example 1—Estimation of Hydrodynamic Coefficients

A preliminary estimation of the hydrodynamic coefficients was developed as presented below. A generic hydrofoil was selected for the submersible vehicle system 10 as described hereinabove. The emphasis was on reliability for different twists, height-to-span (h/b) ratio and angle of attack using low-fidelity tools. This helps to find relevant trends between performance and design variables, which is very useful in the conceptual design stage and allows to identify starting promising solutions for the following detailed development with higher fidelity tools and methodologies. Thus, the Zero-lift drag (C_{D0}) calculation is based on the wetted area (S_{wet}) using predictions of skin-friction models and form-factor estimates. In the case of the induced drag, calculations are obtained using a Vortex Lattice Method (VLM) code.

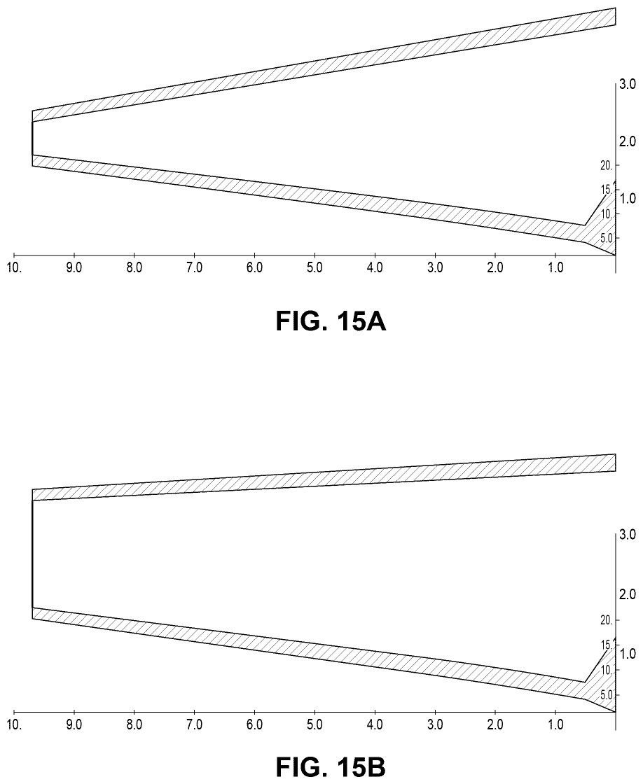

Two configurations were evaluated: a baseline geometry without twist distribution and the current h/b ratio (FIG. 15A), and a modified configuration with twisted airfoil sections and a higher h/b ratio (FIG. 15B). For the modified configuration, the fore and aft wings are characterized by wash-out (i.e., decreasing the incidence angle from the wing root out to the wing tip) and wash-in (i.e., increasing the incidence angle from the root to the tip), respectively. This twist distribution allows one to modify the spanwise lift distribution to get it closer to the optimal solution that minimizes induced drag. Furthermore, a high h/b ratio is selected, to reduce the interference between the fore and aft wings, which increases the span efficiency. Both configurations share the same wingspan and hull length.

TABLE 1
Summary of results.

| | | Induced | | | |
|---|---|---|---|---|---|
| | Span | drag | | Max | Max |
| Configuration | Efficiency | factor | C_{D0} | L/D | C_{L}³/C_{D}² |
| Baseline | 1.1361 | 0.0827 | 0.082 | 19.82 | 164.79 |
| Modified | 1.2631 | 0.0745 | 0.085 | 20.52 | 191.12 |

### Example 2—Simulation Studies

The first study involved simulations with different fluid density and velocities, with the aim to find Reynolds similarity between the concept operating in water and air. The Reynolds number of the model operating in water, at a speed of 2 m/s, is 5.78 million. The same model, operating in air, would have to operate at 30 m/s to equal the operating Reynolds number. No significant differences were obtained in terms of lift and drag coefficients for the different fluids. Once the appropriate velocity was defined the simulations of the models at several angles of attack were performed.

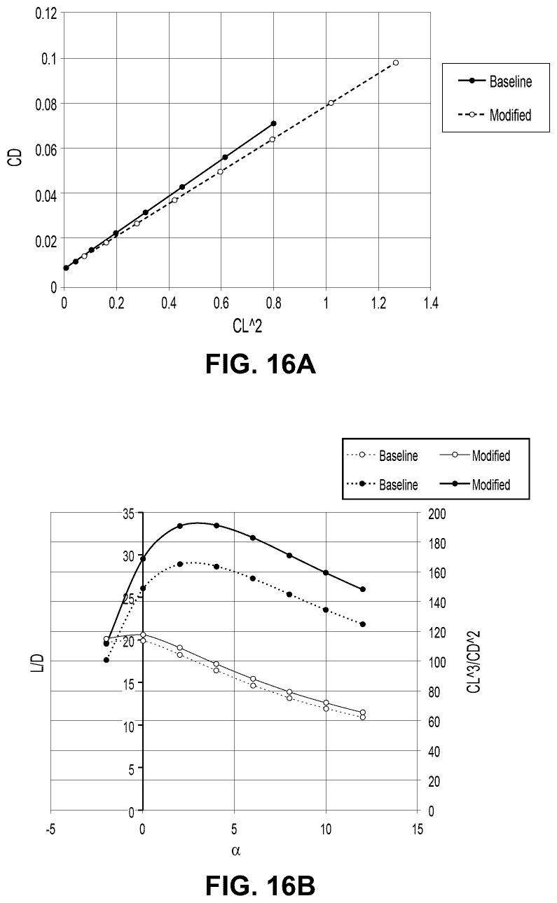

Table 1 below shows a summary of the results from the low-fidelity aerodynamic comparison, while FIGS. 16A and 16B graphically display the complete aerodynamic comparison for several angles of attack.

TABLE 1
Summary of results.

| | | Induced | | | |
|---|---|---|---|---|---|
| | Span | drag | | Max | Max |
| Configuration | Efficiency | factor | C_{D0} | L/D | C_{L}³/C_{D}² |
| Baseline | 1.1361 | 0.0827 | 0.082 | 19.82 | 164.79 |
| Modified | 1.2631 | 0.0745 | 0.085 | 20.52 | 191.12 |

FIG. 16A depicts the variation of drag coefficient with the square of lift coefficient at several angles-of-attack. The graphical plot clearly shows the aerodynamic advantage of the modified configuration, where the induced drag slope (dC_{D}/d C_{L}²) in the linear region is reduced. This indicates that even if the zero-lift drag has increased, the contribution of the induced drag to the total drag is decreasing as the angle-of-attack increases.

FIG. 16B shows the aerodynamic efficiency (L/D) and the endurance parameter (C_{L}³/C_{D}²) as a function of the angle of attack. It is clearly shown therein that the L/D ratio increases for the modified configuration due to the higher h/b ratio. This outcome shows again the positive effect of the box-wing concept in reducing the induced drag. The L/D difference between the configurations is 4.1%. This result directly influences the endurance parameter, showing that the modified configuration presents better results than the baseline configuration. In this case, the C_{L}³/C_{D}² difference between the configurations is 14.13%.

### Example 3—Comparison of Fixed Wing Vehicle Power and Conventional Turbine Power

The maximum power a wing area can harvest compared to a wind turbine swept area is given by the following formulas:

$$\begin{matrix}{Loyd}^{′} s power limit : {P}_{wing} = \frac{4}{27} \frac{1}{2} ρ {S}_{w} {V}_{fluid}^{3} {C}_{L} \frac{{C}_{L}^{2}}{{C}_{D}^{2}} \\ {Betz}^{′} s power limit : {P}_{turbine} = \frac{16}{27} \frac{1}{2} ρ {S}_{w} {V}_{fluid}^{3}\end{matrix}$$

Then, the power generated by the wing compared to wind turbine is (Loyd's power limit divided by Betz's power limit):

$$\frac{{P}_{wing}}{{P}_{turbine}} = \frac{1}{4} {C}_{L} \frac{{C}_{L}^{2}}{{C}_{D}^{2}}$$

That means greater power generation with fixed wings on the water compared to fixed turbines. Also, the capacity factor is larger. Fixed wing vehicles can change direction according to water flow changes (such as tides). For example, for the following estimated value of lift over drag of the Diamond, considering the rotor drag, we have a gain factor of approximately 50 times of wing area compared to conventional turbine area:

$$Estimates : \frac{{C}_{L}}{{C}_{D}} = 14 , {C}_{L} = 1$$

Then, the power generated by the wing compared to wind turbine is:

$$\frac{{P}_{wing}}{{P}_{wingturbine}} \approx 50$$

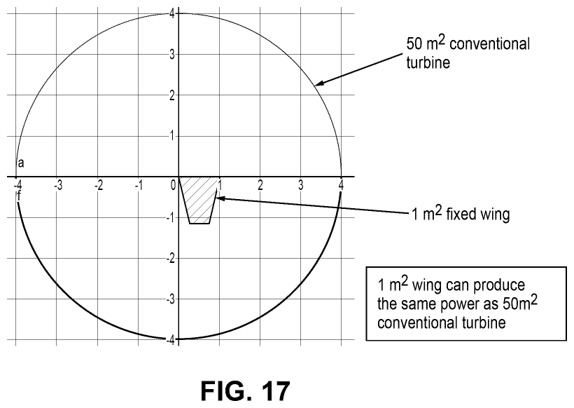

FIG. 17 illustrates such a gain.

Considering the estimated values for the box-wing designs as described for the embodiments herein, the optimum power speed is given by the equation below:

$$Optimum speed : {V}_{wing} = \frac{2}{3} \frac{{C}_{L}}{{C}_{D}} {V}_{fluid} = 9.33 m / sec for water flow = 1 m / sec$$

While reference is made herein to particular embodiments of the invention, various modifications within the skill of those in the art may be envisioned. Therefore, it is to be understood that the invention is not to be limited to the disclosed embodiment, but on the contrary, is intended to cover various modifications and equivalent arrangements included within the spirit and scope thereof.

What is claimed is:

1. A submersible box-winged vehicle system for generating hydroelectric energy using naturally occurring tidal flows and/or currents in a body of water, the vehicle system comprising:
a submersible hull;
an upright dorsal fin extending from an aft portion of the submersible hull;
port and starboard wing assemblies each having respective proximal ends joined to a forward region of the hull an and an upper region of the dorsal fin so as to establish a box wing configuration; and
electrical power generation units attached to the port and starboard wings, wherein each of the electrical power generation units includes a generator and a marine propeller operatively connected to the generator so as to cause the generator to generate electrical energy in response to the marine propeller turning, wherein
the vehicle system when submerged in a body of water allows tidal flows and/or currents associated with the body of water to responsively turn the marine propeller of each of the electrical power units thereby generating electrical energy by the generator operably associated therewith.

2. The submersible box-winged vehicle system according to claim 1, wherein the hull is generally cylindrically shaped.

3. The submersible box-winged vehicle system according to claim 1, wherein each of the port and starboard wing assemblies include:
an aftward swept and upwardly sloped fore wing,
a forward swept and downwardly sloped aft wing, and
a curved wing tip joining the distal terminal ends of the fore and aft wings, wherein
the port and starboard wing assemblies define a diamond-shaped box wing configuration.

4. The submersible box-winged vehicle system according to claim 1, wherein the dorsal fin includes a moveable rudder to control movement of the hull about a yaw axis thereof.

5. The submersible box-winged vehicle system according to claim 4, wherein the port and starboard wing assemblies comprise moveable port and starboard hydroplane control surfaces to control movement of the hull about roll and pitch axes thereof.

6. The submersible box-winged vehicle system according to claim 5, wherein each of the port and starboard wing assemblies include:
an aftward swept and upwardly sloped fore wing,
a forward swept and downwardly sloped aft wing, and
a curved wing tip joining the distal terminal ends of the fore and aft wings, wherein
the port and starboard wing assemblies define a diamond-shaped box wing configuration.

7. The submersible box-winged vehicle system according to claim 6, wherein the aft wing of each of the port and starboard wing assemblies comprises are respective one of the port and starboard hydroplane control surfaces.

8. The submersible box-winged vehicle system according to claim 7, wherein each of the fore and aft wings of each of the port and starboard wing assemblies comprises at least one of the electrical power generation units.

9. The submersible box-winged vehicle system according to claim 8, wherein each of the fore and aft wings of each of the port and starboard wing assemblies comprises a plurality of the electrical power generation units.

10. The submersible box-winged vehicle system according to claim 1, wherein each of the electrical power generation units comprise a nacelle attached to a respective one of the port and starboard wings, wherein each generator is enclosed by a respective nacelle.

11. The submersible box-winged vehicle system according to claim 1, further comprising a ballast system to controllably adjust buoyancy of the hull and thereby allow submersion and surfacing of the vehicle system.

12. The submersible box-winged vehicle system according to claim 11, wherein the ballast system comprises at least one ballast tank to accept a volume of water as ballast for the hull.

13. The submersible box-winged vehicle system according to claim 12, wherein the ballast system comprised a compressed air tank adapted to contain a volume of compressed air, the compressed air tank being operably connected to the at least one ballast tank to thereby allow water to be expelled therefrom in response to compressed air being released from the compressed air tank and into the at least one ballast tank.

14. A hydroelectric generation system comprising:
the submersible box-winged vehicle system according to claim 1 submerged in a body or water so as to be exposed to naturally occurring tidal flows and/or currents in the body of water and thereby generate hydroelectric energy therefrom, and
an electrical power substation associated with an onshore power grid, the substation receiving hydroelectric energy from the vehicle system for supply to the onshore power grid.

15. The hydroelectric generation system according to claim 14, which further comprises at least one offshore wind-driven turbine system, wherein the submersible box-winged vehicle system is tethered to the at least one wind-driven turbine system so as to provide supplemental electrical energy to the same.

16. A hydrogen gas generation system comprising:
an electrolyzer to generate hydrogen gas by dissociation of water molecules with electrical energy; and
the submersible box-winged vehicle system according to claim 1 submerged in a body or water so as to be exposed to naturally occurring tidal flows and/or water currents in the body of water and thereby generate hydroelectric energy therefrom, wherein
the hydroelectric energy generated by the submerged box-wing vehicle system is supplied to the electrolyzer to thereby generate hydrogen gas by the disassociation of the water molecules.

17. The hydrogen gas generation system according to claim 16, wherein the hydrogen gas generation system includes an offshore platform, and wherein the submersible box-winged vehicle system is tethered to the offshore platform.

18. A method of generating hydroelectric energy comprising the steps of:
(a) providing the submersible box-winged vehicle system according to claim 1;
(b) submerging the submersible box-winged vehicle system in a body of water having naturally occurring tidal flows and/or currents; and
(c) allowing the submersible box-winged vehicle system to generate hydroelectric energy by interaction with the naturally occurring tidal flows and/or currents in the body of water.

19. The method according to claim 18, which further comprises tethering the submersible box-winged vehicle system at an offshore location conducive to having the vehicle system interact with the tidal flows and/or water currents in the body of water.

20. The method according to claim 18, which further comprises controllably maneuvering the submersible box-winged vehicle system when submerged in the body of water so as to cause the box-winged vehicle system to travel in a substantially arcuate operational path therein.
